(19) United States
(12) Patent Application Publication
(10) Pub. No.: US 2023/0342683 A1
(43) Pub. Date: Oct. 26, 2023

(54) METHOD AND SYSTEM FOR PARTICIPANT IDENTIFICATION AND RECORD AUGMENTATION

(71) Applicant: JPMorgan Chase Bank, N.A., New York, NY (US)

(72) Inventors: Philip GREAVES, Hampshire (GB); Daniel ZINKIN, London (GB); Bret GOLDSMITH, Sugar Land, TX (US)

(73) Assignee: JPMorgan Chase Bank, N.A., New York, NY (US)

(21) Appl. No.: 18/137,671

(22) Filed: Apr. 21, 2023

Related U.S. Application Data
(60) Provisional application No. 63/334,370, filed on Apr. 25, 2022.

(51) Int. Cl. G06Q 10/0631

(52) U.S. Cl. CPC G06Q 10/063114

(57) ABSTRACT

A method for facilitating automated participant record augmentation via a secured repository is disclosed. The method includes aggregating, via an application programming interface, employee data from sources according to a predetermined schedule, the employee data including data elements; associating the data elements with a corresponding employee; persisting the association and the data elements in the secured repository; receiving an indication that an interaction has been initiated, the interaction corresponding to a telecommunications interaction between several participants; identifying the persisted data elements that correspond to each of the participants based on the association; and automatically augmenting an interaction record that corresponds to the interaction with the identified data elements.

### CROSS-REFERENCE TO RELATED APPLICATIONS

This application claims the benefit of U.S. Provisional Patent Application Ser. No. 63/334,370, filed Apr. 25, 2022, which is hereby incorporated by reference in its entirety.

### BACKGROUND

### 1. Field of the Disclosure

This technology generally relates to methods and systems for participant identification, and more particularly to methods and systems for providing automated identification of telecommunication participants to facilitate automated record augmentation via a secured repository.

### 2. Background Information

Many business entities maintain detailed records of telecommunication interactions such as, for example, telephone interactions and electronic mail interactions that relate to business operations. Often, maintenance of the detailed records is required for business and regulatory compliance. Historically, implementations of conventional techniques for maintaining the detailed records have resulted in varying degrees of success with respect to accurate and efficient participant identification based on data available from each telecommunication interaction.

One drawback of using the conventional record maintenance techniques is that in many instances, detailed participant information is not obtainable based on available telecommunication interaction data such as, for example, telephone numbers of external participants who are associated with other entities. As a result, records of telecommunication interactions involving external participants are often incomplete. Additionally, due to the inherent value and sensitive nature of the detailed participant information, a conventional participant information database for identifying the external participants may be prone to abuse.

Therefore, there is a need for a centralized repository of detailed participant information that is secured based on access limits to facilitate automated participant identification and automated record augmentation for telecommunication interactions.

### SUMMARY

The present disclosure, through one or more of its various aspects, embodiments, and/or specific features or sub-components, provides, inter alia, various systems, servers, devices, methods, media, programs, and platforms for providing automated identification of telecommunication participants to facilitate automated record augmentation via a secured repository.

According to an aspect of the present disclosure, a method for facilitating automated participant identification and record augmentation via a secured repository is disclosed. The method is implemented by at least one processor. The method may include aggregating, via an application programming interface, employee data from at least one source according to a predetermined schedule, the employee data may include at least one data element; associating the at least one data element with a corresponding employee; persisting the association and the at least one data element in the secured repository; receiving an indication that at least one interaction has been initiated, the at least one interaction may correspond to a telecommunications interaction between a plurality of participants; identifying the persisted at least one data element that corresponds to each of the plurality of participants based on the association; and automatically augmenting at least one interaction record that corresponds to the at least one interaction with the identified at least one data element.

In accordance with an exemplary embodiment, the at least one data element may include employee information that relates to at least one from among employee name information, employee contact information, and employee association information.

In accordance with an exemplary embodiment, the employee contact information may include at least one from among telephone number information, email address information, and username information; and wherein the employee association information may include at least one from among corresponding employee identifier information and corresponding employer information.

In accordance with an exemplary embodiment, the method may further include assigning a time characteristic to each of the at least one data element prior to persistence in the secured repository; determining, by using the time characteristic, whether the at least one data element satisfies a predetermined threshold, the predetermined threshold may relate to a predetermined retention time period; and purging the at least one data element from the secured repository when the predetermined threshold is satisfied.

In accordance with an exemplary embodiment, the method may further include receiving, via the application programming interface, at least one external request that corresponds to at least one external telecommunication interaction, the at least one external request may include unidentified participant information for at least one unidentified participant; identifying the persisted at least one data element that corresponds to the at least one unidentified participant based on the association and the unidentified participant information; generating at least one data set based on a predetermined guideline, the at least one data set may include information relating to the identified at least one data element; and transmitting, via the application programming interface, the at least one data set in response to the at least one external request.

In accordance with an exemplary embodiment, the predetermined guideline may relate to a distribution threshold that limits availability of the at least one data element for each of the at least one external request.

In accordance with an exemplary embodiment, prior to associating the at least one data element with a corresponding employee, the method may further include automatically validating the aggregated employee data; capturing, based on a result of the automatically validating, supplemental data that corresponds to each of the at least one data element; and associating the captured supplemental data with the corresponding at least one data element.

In accordance with an exemplary embodiment, to automatically validate the aggregated employee data, the method may further include determining whether at least one telephone number in the aggregated employee data is duplicated; and determining whether contact information in the aggregated employee data matches at least one corresponding contact format, the at least one corresponding contact format may include at least one from among a phone number format and a name format.

In accordance with an exemplary embodiment, at least one data retention policy may be implemented to safeguard the at least one data element persisted in the secured repository, the at least one data retention policy may include at least one from among an application programming interface limitation policy, a data persistence characteristic policy, and a permissible data retention preference policy.

According to an aspect of the present disclosure, a computing device configured to implement an execution of a method for facilitating automated participant identification and record augmentation via a secured repository is disclosed. The computing device including a processor; a memory; and a communication interface coupled to each of the processor and the memory, wherein the processor may be configured to aggregate, via an application programming interface, employee data from at least one source according to a predetermined schedule, the employee data may include at least one data element; associate the at least one data element with a corresponding employee; persist the association and the at least one data element in the secured repository; receive an indication that at least one interaction has been initiated, the at least one interaction may correspond to a telecommunications interaction between a plurality of participants; identify the persisted at least one data element that corresponds to each of the plurality of participants based on the association; and automatically augment at least one interaction record that corresponds to the at least one interaction with the identified at least one data element.

In accordance with an exemplary embodiment, the at least one data element may include employee information that relates to at least one from among employee name information, employee contact information, and employee association information.

In accordance with an exemplary embodiment, the employee contact information may include at least one from among telephone number information, email address information, and username information; and wherein the employee association information may include at least one from among corresponding employee identifier information and corresponding employer information.

In accordance with an exemplary embodiment, the processor may be further configured to assign a time characteristic to each of the at least one data element prior to persistence in the secured repository; determine, by using the time characteristic, whether the at least one data element satisfies a predetermined threshold, the predetermined threshold may relate to a predetermined retention time period; and purge the at least one data element from the secured repository when the predetermined threshold is satisfied.

In accordance with an exemplary embodiment, the processor may be further configured to receive, via the application programming interface, at least one external request that corresponds to at least one external telecommunication interaction, the at least one external request may include unidentified participant information for at least one unidentified participant; identify the persisted at least one data element that corresponds to the at least one unidentified participant based on the association and the unidentified participant information; generate at least one data set based on a predetermined guideline, the at least one data set may include information relating to the identified at least one data element; and transmit, via the application programming interface, the at least one data set in response to the at least one external request.

In accordance with an exemplary embodiment, the predetermined guideline may relate to a distribution threshold that limits availability of the at least one data element for each of the at least one external request.

In accordance with an exemplary embodiment, prior to associating the at least one data element with a corresponding employee, the processor may be further configured to automatically validate the aggregated employee data; capture, based on a result of the automatic validation, supplemental data that corresponds to each of the at least one data element; and associate the captured supplemental data with the corresponding at least one data element.

In accordance with an exemplary embodiment, to automatically validate the aggregated employee data, the processor may be further configured to determine whether at least one telephone number in the aggregated employee data is duplicated; and determine whether contact information in the aggregated employee data matches at least one corresponding contact format, the at least one corresponding contact format may include at least one from among a phone number format and a name format.

In accordance with an exemplary embodiment, the processor may be further configured to implement at least one data retention policy to safeguard the at least one data element persisted in the secured repository, the at least one data retention policy may include at least one from among an application programming interface limitation policy, a data persistence characteristic policy, and a permissible data retention preference policy.

According to an aspect of the present disclosure, a non-transitory computer readable storage medium storing instructions for facilitating automated participant identification and record augmentation via a secured repository is disclosed. The storage medium including executable code which, when executed by a processor, may cause the processor to aggregate, via an application programming interface, employee data from at least one source according to a predetermined schedule, the employee data may include at least one data element; associate the at least one data element with a corresponding employee; persist the association and the at least one data element in the secured repository; receive an indication that at least one interaction has been initiated, the at least one interaction may correspond to a telecommunications interaction between a plurality of participants; identify the persisted at least one data element that corresponds to each of the plurality of participants based on the association; and automatically augment at least one interaction record that corresponds to the at least one interaction with the identified at least one data element.

In accordance with an exemplary embodiment, the at least one data element may include employee information that relates to at least one from among employee name information, employee contact information, and employee association information.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for providing automated identification of telecommunication participants to facilitate automated record augmentation via a secured repository.

FIG. 4 is a flowchart of an exemplary process for implementing a method for providing automated identification of telecommunication participants to facilitate automated record augmentation via a secured repository.

FIG. 5 is a flow diagram of an exemplary first-party process for implementing a method for providing automated identification of telecommunication participants to facilitate automated record augmentation via a secured repository.

FIG. 6 is a flow diagram of an exemplary third-party process for implementing a method for providing automated identification of telecommunication participants to facilitate automated record augmentation via a secured repository.

FIG. 7 is a diagram of exemplary data privacy processes for implementing a method for providing automated identification of telecommunication participants to facilitate automated record augmentation via a secured repository.

### DETAILED DESCRIPTION

Through one or more of its various aspects, embodiments and/or specific features or sub-components of the present disclosure are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

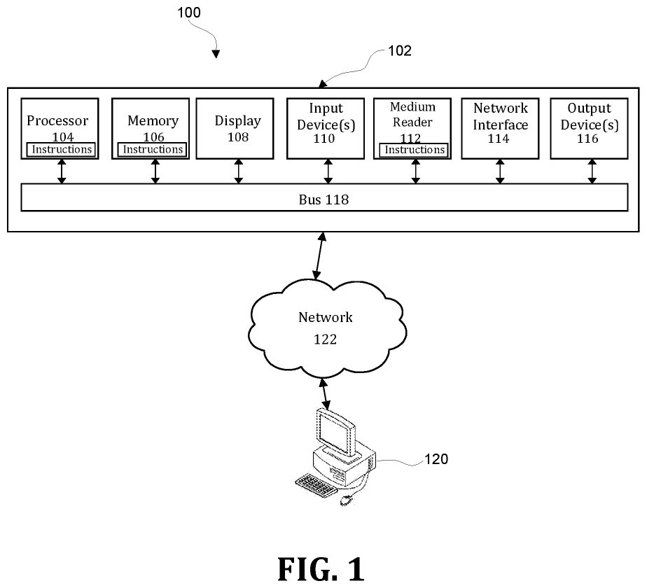

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disc read only memory (CD-ROM), digital versatile disc (DVD), floppy disk, blu-ray disc, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other type of display, examples of which are well known to persons of skill in the art.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for providing automated identification of telecommunication participants to facilitate automated record augmentation via a secured repository.

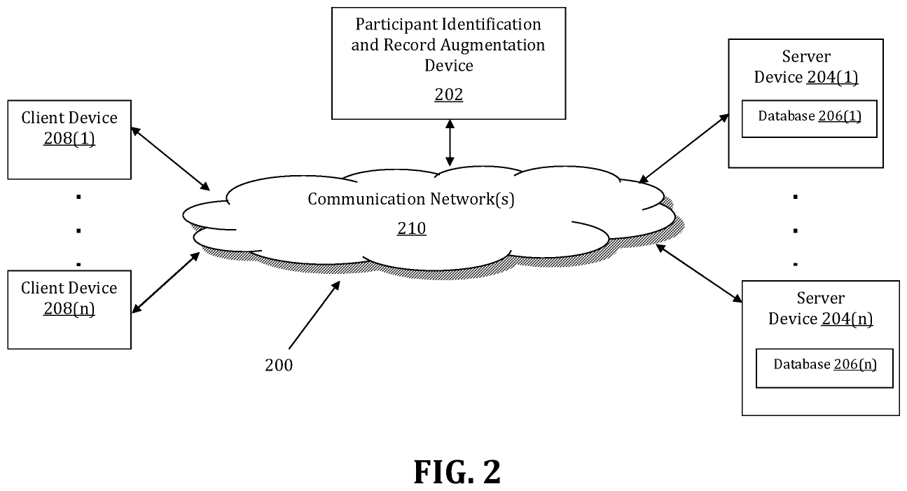

Referring to FIG. 2, a schematic of an exemplary network environment 200 for implementing a method for providing automated identification of telecommunication participants to facilitate automated record augmentation via a secured repository is illustrated. In an exemplary embodiment, the method is executable on any networked computer platform, such as, for example, a personal computer (PC).

The method for providing automated identification of telecommunication participants to facilitate automated record augmentation via a secured repository may be implemented by a Participant Identification and Record Augmentation (PIRA) device 202. The PIRA device 202 may be the same or similar to the computer system 102 as described with respect to FIG. 1. The PIRA device 202 may store one or more applications that can include executable instructions that, when executed by the PIRA device 202, cause the PIRA device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the PIRA device 202 itself, may be located in virtual server(s) running in a cloud-based computing environment rather than being tied to one or more specific physical network computing devices. Also, the application(s) may be running in one or more virtual machines (VMs) executing on the PIRA device 202. Additionally, in one or more embodiments of this technology, virtual machine(s) running on the PIRA device 202 may be managed or supervised by a hypervisor.

In the network environment 200 of FIG. 2, the PIRA device 202 is coupled to a plurality of server devices 204(1)-204(n) that hosts a plurality of databases 206(1)-206(n), and also to a plurality of client devices 208(1)-208(n) via communication network(s) 210. A communication interface of the PIRA device 202, such as the network interface 114 of the computer system 102 of FIG. 1, operatively couples and communicates between the PIRA device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the PIRA device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and PIRA devices that efficiently implement a method for providing automated identification of telecommunication participants to facilitate automated record augmentation via a secured repository.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The PIRA device 202 may be a standalone device or integrated with one or more other devices or apparatuses, such as one or more of the server devices 204(1)-204(n), for example. In one particular example, the PIRA device 202 may include or be hosted by one of the server devices 204(1)-204(n), and other arrangements are also possible. Moreover, one or more of the devices of the PIRA device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the PIRA device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store data that relates to employee data, schedule data, data elements, associations, indications, telecommunication interactions, interaction records, employee information, time characteristics, thresholds, and external requests.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the PIRA device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the PIRA device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the PIRA device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the PIRA device 202, the server devices 204(1)-204(n), or the client devices 208(1)-208(n), for example, may be configured to operate as virtual instances on the same physical machine. In other words, one or more of the PIRA device 202, the server devices 204(1)-204(n), or the client devices 208(1)-208(n) may operate on the same physical device rather than as separate devices communicating through communication network(s) 210. Additionally, there may be more or fewer PIRA devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

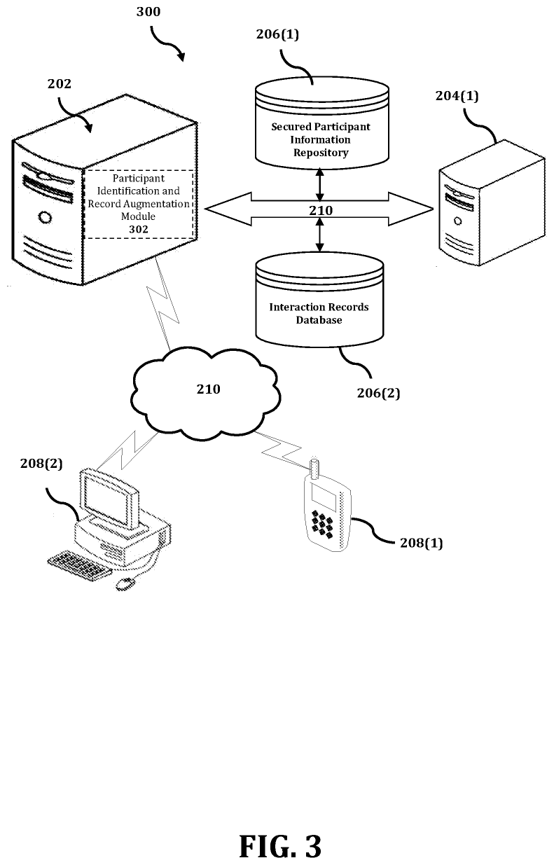

The PIRA device 202 is described and shown in FIG. 3 as including a participant identification and record augmentation module 302, although it may include other rules, policies, modules, databases, or applications, for example. As will be described below, the participant identification and record augmentation module 302 is configured to implement a method for providing automated identification of telecommunication participants to facilitate automated record augmentation via a secured repository.

An exemplary process 300 for implementing a mechanism for providing automated identification of telecommunication participants to facilitate automated record augmentation via a secured repository by utilizing the network environment of FIG. 2 is shown as being executed in FIG. 3. Specifically, a first client device 208(1) and a second client device 208(2) are illustrated as being in communication with PIRA device 202. In this regard, the first client device 208(1) and the second client device 208(2) may be “clients” of the PIRA device 202 and are described herein as such. Nevertheless, it is to be known and understood that the first client device 208(1) and/or the second client device 208(2) need not necessarily be “clients” of the PIRA device 202, or any entity described in association therewith herein. Any additional or alternative relationship may exist between either or both of the first client device 208(1) and the second client device 208(2) and the PIRA device 202, or no relationship may exist.

Further, PIRA device 202 is illustrated as being able to access a secured participant information repository 206(1) and an interaction records database 206(2). The participant identification and record augmentation module 302 may be configured to access these databases for implementing a method for providing automated identification of telecommunication participants to facilitate automated record augmentation via a secured repository.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the PIRA device 202 via broadband or cellular communication. Of course, these embodiments are merely exemplary and are not limiting or exhaustive.

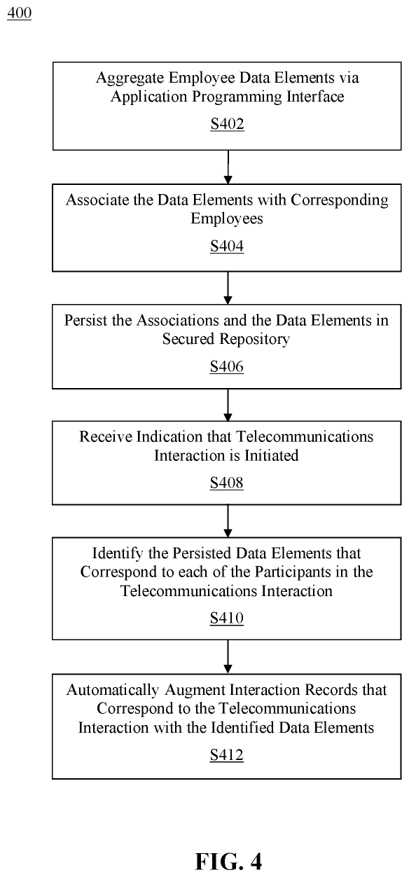

Upon being started, the participant identification and record augmentation module 302 executes a process for providing automated identification of telecommunication participants to facilitate automated record augmentation via a secured repository. An exemplary process for providing automated identification of telecommunication participants to facilitate automated record augmentation via a secured repository is generally indicated at flowchart 400 in FIG. 4.

In the process 400 of FIG. 4, at step S402, employee data may be aggregated from various sources. The employee data may be aggregated according to a predetermined schedule via an application programming interface (API). In an exemplary embodiment, the employee data may include data elements. The data elements may relate to basic units of information that have a unique meaning and subcategories of distinct values. The data elements may correspond to an atomic unit of data that has precise meaning and/or precise semantics.

In another exemplary embodiment, the data elements may include employee information that relates to at least one from among employee name information, employee contact information, and employee association information. As will be appreciated by a person of ordinary skill in the art, the employee information may correspond to any information for a person who is associated in any way with an entity implementing the disclosed invention. Consistent with present disclosures, the employee information may include any information that relates to at least one from among employees, supervisors, managers, directors, executives, board members, and employers who are associated with the entity.

In another exemplary embodiment, the employee contact information may include at least one from among telephone number information, email address information, and username information. The employee contact information may relate to any information associated with an employee that may be usable to identify and/or communicate with the employee. In another exemplary embodiment, the employee association information may include at least one from among corresponding employee identifier information and corresponding employer information. The employee association information may relate to any information associated with an employee that relates to the employment of the employee.

In another exemplary embodiment, the various sources may include first-party data sources. The first-party data sources may correspond to an entity that both implements the disclosed invention as well as provides the data for the disclosed invention. For example, a first-party data source may provide internal employee information as employee data for aggregation. In another exemplary embodiment, the various sources may include third-party data sources. The third-party data sources may correspond to an external provider of data for the disclosed invention. For example, the employee data may be aggregated from external entities that are not directly associated with the entity implementing the disclosed invention.

In another exemplary embodiment, the predetermined schedule may relate to a plan for carrying out a process and/or a procedure at a particular time. The predetermined schedule may dictate when and where the employee data may be aggregated. For example, the predetermined schedule may dictate that the employee data is aggregated from external entity A during nonbusiness hours. In another exemplary embodiment, the predetermined schedule may dictate the frequency of aggregation for the employee data. For example, the predetermined schedule may dictate that the employee data may be aggregated once a day, once a week, or once a month. In another exemplary embodiment, the predetermined schedule may be predetermined by the various sources. For example, the various sources may dictate how often the employee data may be aggregated based on business and security guidelines.

At step S404, the data elements may be associated with a corresponding employee. In an exemplary embodiment, the aggregated employee data may be preprocessed to facilitate the association of the data elements with the corresponding employee. The preprocessing of the aggregated employee data may include generating a structured data set from raw employee data. For example, the employee data may be aggregated from a variety of sources in a variety of file formats that must be converted into a compatible file format to facilitate the association of the data elements. In another exemplary embodiment, the preprocessing of the aggregated employee data may identify relevant information to generate a structured data set from any raw employee data. For example, relevant information may be identified from raw employee data that are incomplete and/or include formatting errors to generate the structured data set.

In another exemplary embodiment, the aggregated employee data may be parsed and mapped according to a file system cataloging structure such as, for example, an employee directory that contains references to other computer files. The employee directory may be utilized to facilitate the association of the data elements with the corresponding employees. In another exemplary embodiment, the employee directory may relate to an internal file system cataloging structure. For example, the employee directory may correspond to an internal employee listing of an organization implementing the disclosed invention. In another exemplary embodiment, the employee directory may relate to an external file system cataloging structure. For example, the employee directory may correspond to an external employee listing that is retrieved from an external source together with the aggregated employee data.

In another exemplary embodiment, the employee may relate to a person who is associated with the entities in the present disclosure. As will be appreciated by a person of ordinary skill in the art, the employee may correspond to any person who is associated in any way with an entity implementing the disclosed invention. Consistent with present disclosures, the employee may include any person such as, for example, an employee, a supervisor, a manager, a director, an executive, a board member, and an employer who is associated with the entity.

In another exemplary embodiment, a validation process may be initiated prior to the association. The validation process may ensure that an entity is recognized, a phone number is not duplicated, a phone number format conforms, and a name format conforms. Data that fails validation may not proceed to the association processing. In another exemplary embodiment, additional data such as, for example, processed dates and data masking requirements may be captured to supplement the aggregated employee data. Participating entities may be notified via the API with a notification of data load status.

At step S406, the association and the data elements may be persisted in a secured repository. In an exemplary embodiment, the secured repository may correspond to an organized collection of structured information that is stored electronically in a computer system. The secured repository may be controlled by a database management system that serves as an interface between an end-user and the secured repository. For example, the database management system may enable data creation, data reading, data updating, and data deletion operations in the secured repository.

In another exemplary embodiment, the secured repository may be accessible via an application programming interface (API). The API may relate to a software interface that facilitates a connection between computers and/or between computer programs by defining interaction protocols. In another exemplary embodiment, the secured repository may be safeguarded to prevent unwanted access and manipulation of the stored data. The safeguard may include API limitations such as, for example, file export limitations and/or data export limitations as defined by corresponding interaction protocols. For example, data stored in the secured repository may only be accessible via an API and each request may only return a single data set per employee.

In another exemplary embodiment, the secured repository may implement data retention policies that safeguard stored data. The data retention policies may include a data persistence characteristic such as, for example, a predetermined time period for persisting data. For example, the predetermined time period may indicate that data is retained for four weeks and then deleted from searches. Similarly, the predetermined time period may require that queries only search within data provided in the last four weeks. In another exemplary embodiment, the data retention policies may include permissible data retention preferences. For example, the data retention policies may indicate that logging data may be retained only for the purposes of activity compliance, feature performance analysis, and feature planning.

In another exemplary embodiment, the data retention policies may include any combination of API limitations, data persistence characteristics, and permissible data retention preferences. For example, the secured repository may not retain activity data, querying history data, and/or logging data beyond four weeks. Further, the secured repository may only be accessible via a specified API and may not support database queries and database outputs of any format—online or offline.

In another exemplary embodiment, the data retention policies may include agreed-upon guidelines such as, for example, agreed-upon fair use agreements between a plurality of entities. The fair use agreements may require that requests are to be submitted to enrich messages that are stored in digital vaults and/or data retention solutions according to a stated purpose. As such, entities may only submit requests for immediate concerns, and general requests and/or data mining requests are not permissible. In another exemplary embodiment, the agreed-upon guideline may require that each of the entities contributing to the secured repository be responsible for ensuring data quality, data accuracy, and timeliness of data updates. Thus, the secured repository may not be responsible for sharing inaccurate data such as, for example, inaccurate details in response to a request.

In another exemplary embodiment, data controls may be applied directly to data elements to safeguard access to the data elements. The data controls may be applied by assigning a time characteristic to each of the data elements prior to persistence in the secured repository. The time characteristic may relate to a time associated with each of the data elements such as, for example, a time when the data elements are retrieved from a source. Then, whether the data elements satisfy a predetermined threshold may be determined by using the time characteristic. The predetermined threshold may relate to a predetermined retention time period that corresponds to a retention policy consistent with disclosures in the present application. For example, the predetermined threshold may include a four-week threshold which corresponds to a retention policy for employee data. The secured repository may purge the data elements when the predetermined threshold is satisfied.

In another exemplary embodiment, the secured repository may include a distributed ledger. The distributed ledger may relate to a blockchain that includes a plurality of blocks corresponding to a growing list of records. In another exemplary embodiment, each of the plurality of blocks on the blockchain may include digital pieces of information such as, for example, a phone number and names that correspond to a participant. Each of the plurality of blocks on the blockchain may also include identifying data which distinguishes a particular block from other blocks on the blockchain. In another exemplary embodiment, each block may utilize a unique code such as, for example, a hash as identifying data. The hashes may include cryptographic codes that are automatically generated by an algorithm.

At step S408, an indication that an interaction has been initiated may be received. The interaction may correspond to a telecommunications interaction between a plurality of participants. The interaction may include participant information such as, for example, participant identifier information. In an exemplary embodiment, the indication may relate to a real-time initiation of the interaction. For example, the indication may be received in real-time as a participant initiates a video teleconferencing call. Consistent with disclosures in the present application, the real-time indication may enable identification of supplemental participant information for an interaction as the interaction occurs. For example, employer information may be identified and displayed for all participants of an ongoing video teleconferencing call.

In another exemplary embodiment, the indication may relate to a previously initiated interaction. For example, the indication may be received at the conclusion of a video teleconferencing call when interaction details are logged. Consistent with disclosures in the present application, the indication of a previously initiated interaction may enable augmentation of interaction records. For example, employer information may be identified and augmented in a corresponding interaction record for all participants of a video teleconferencing call.

In another exemplary embodiment, the telecommunications interaction may include transmission of information by various types of technologies over wire, radio, optical, and/or other electromagnetic systems. The telecommunications interaction may correspond to communication between a plurality of participants over a distance by cable, telegraph, telephone, and/or broadcasting. For example, the telecommunications interaction may include a telephone call, a video teleconferencing call, a text message, an electronic mail message, and a communication application that utilizes a public networked environment such as the Internet.

At step S410, the persisted data elements that correspond to each of the participants may be identified based on the association. In an exemplary embodiment, the persisted data elements may be identified in response to the received indication that an interaction has been initiated. For example, when the indication is received, the persisted data elements that correspond to each of the participants of the initiated interaction may be identified in the secured repository. Consistent with disclosures in the present application, the persisted data elements may be identified in real-time as well as in response to a previously initiated interaction.

At step S412, interaction records that correspond to the interaction may be automatically augmented with the identified data elements. In an exemplary embodiment, the interaction records may relate to interaction documentations that are generated to log employee interactions. The interaction documentations may be required based on guidelines such as, for example, business guidelines and regulatory guidelines. In another exemplary embodiment, consistent with disclosures in the present application, the augmentation of interaction records may be initiated automatically as well as on an ad-hoc basis. For example, employer information may be automatically identified and automatically augmented in a corresponding interaction record for all participants of a video teleconferencing call.

In another exemplary embodiment, external requests for participant information in the secured repository may be received from a third-party. The external requests that correspond to external telecommunication interactions may be received via the application programming interface (API). The external requests may include unidentified participant information such as, for example, phone numbers for unidentified participants of the external telecommunication interactions. For example, the external request may ask for an employee name of a particular unidentified participant in a particular external telecommunication interaction.

Then, the persisted data elements that correspond to the unidentified participants may be identified based on the association and the unidentified participant information. For example, employee names that correspond to the unidentified participants may be identified by using the unidentified participant information. A data set may be generated based on a predetermined guideline in response to the external request. The data set may include information that relates to the identified data elements. Consistent with disclosures in the present application, the predetermined guideline may relate to a distribution threshold such as, for example, an amount of data retrievable by an external third-party that limits availability of the data elements for each of the external requests. Finally, the generated data set may be transmitted via the API in response to the external requests.

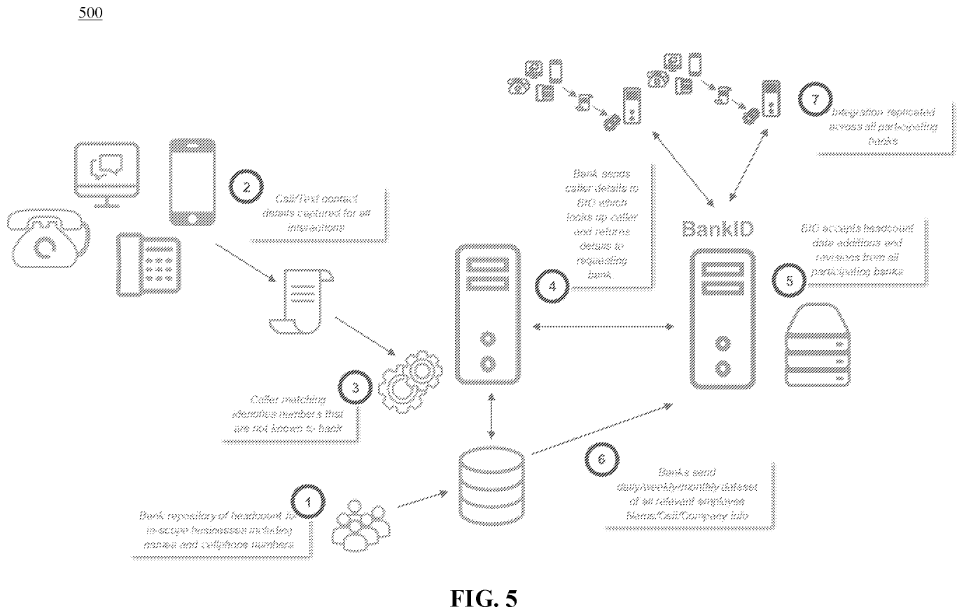

FIG. 5 is a flow diagram 500 of an exemplary first-party process for implementing a method for providing automated identification of telecommunication participants to facilitate automated record augmentation via a secured repository. In FIG. 5, the automated identification of telecommunication participants and the automated augmentation of interaction records may be internally implemented.

As illustrated in FIG. 5, at step 1, a bank repository headcount for in-scope businesses may be maintained. The repository may include names and cellphone numbers for each headcount. At step 2, call and/or text contact details may be captured for all interactions. At step 3, caller matching may identify numbers that are not known to the bank. At step 4, the bank may send caller details to the secured repository which looks up caller information and returns details to the requesting bank. At step 5, the secured repository may accept headcount data additions and revisions from all participating banks. At step 6, the banks may send daily/weekly/monthly dataset of all relevant employee name information, cellular information, and company information. At step 7, the integration may be replicated across all participating banks consistent with disclosures in the present application.

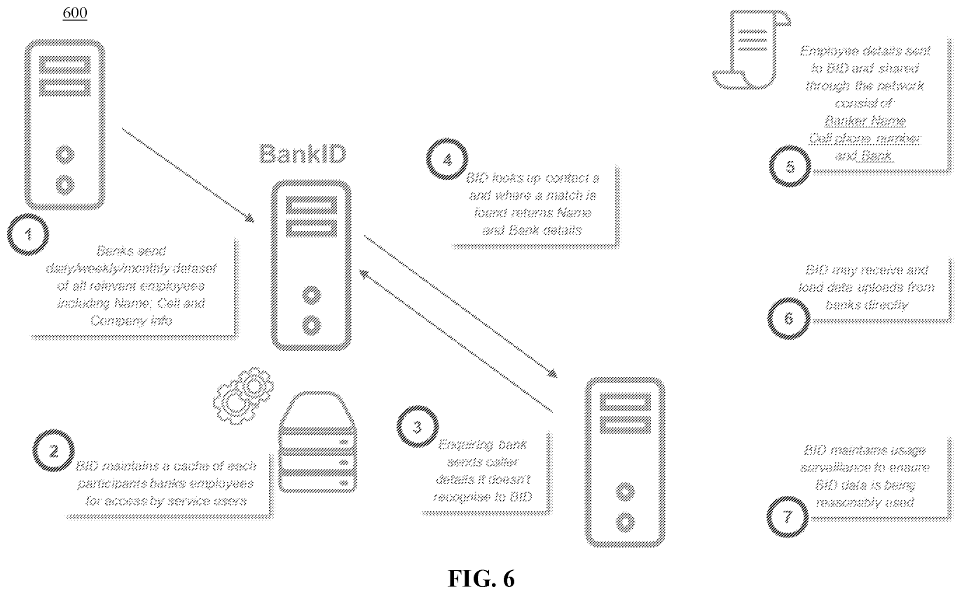

FIG. 6 is a flow diagram 600 of an exemplary third-party process for implementing a method for providing automated identification of telecommunication participants to facilitate automated record augmentation via a secured repository. In FIG. 6, the automated identification of telecommunication participants and the automated augmentation of interaction records may be externally implemented by a third-party provider.

As illustrated in FIG. 6, at step 1, participating banks may send daily/weekly/monthly data sets for all relevant employees. The data sets may include cellular information and company information. At step 2, the secured repository may maintain a cache of each participating bank's employee information for access by service users. At step 3, enquiring banks may send unknown caller details to the secured repository for identification. At step 4, the secured repository may look up contact information and return employee name details and employment details. Consistent with disclosures in the present application, employee details such as, for example, banker name, cell phone number, and bank information may be sent to the secured repository and shared through the network. The secured repository may receive and load data directly from participating banks. The secured repository may implement usage surveillance to ensure that data is reasonably used.

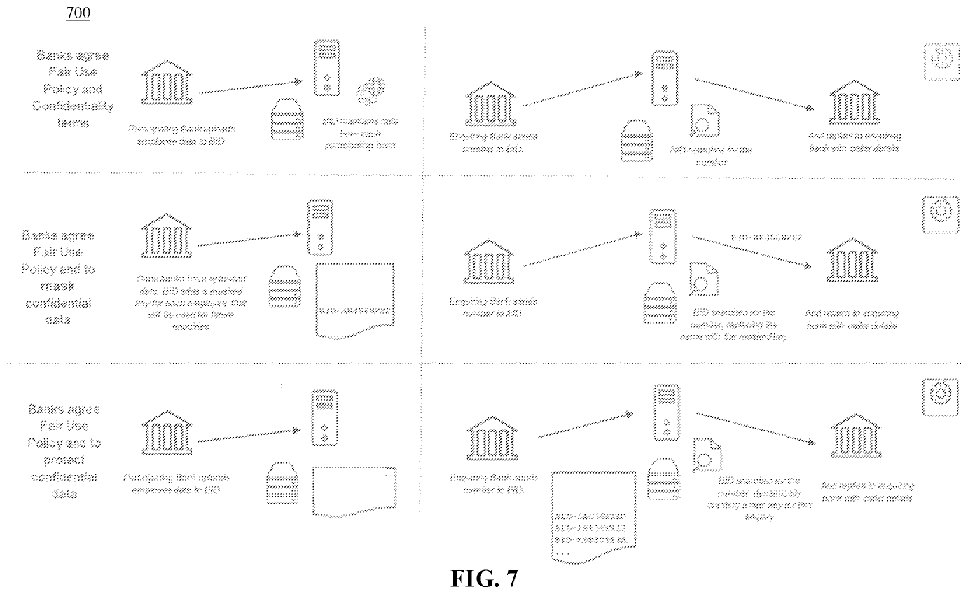

FIG. 7 is a diagram 700 of exemplary data privacy processes for implementing a method for providing automated identification of telecommunication participants to facilitate automated record augmentation via a secured repository. As illustrated in FIG. 7, the data privacy processes may include a first process where participating banks agree to a fair use policy and confidentiality terms. The data privacy processes may include a second process where the participating banks agree to a fair use policy and to mask confidential data. The data privacy processes may include a third process where the participating banks agree to a fair use policy and to protect confidential data.

Accordingly, with this technology, an optimized process for providing automated identification of telecommunication participants to facilitate automated record augmentation via a secured repository is disclosed.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for facilitating automated participant identification and record augmentation via a secured repository, the method being implemented by at least one processor, the method comprising:
aggregating, by the at least one processor via an application programming interface, employee data from at least one source according to a predetermined schedule, the employee data including at least one data element;
associating, by the at least one processor, the at least one data element with a corresponding employee;
persisting, by the at least one processor, the association and the at least one data element in the secured repository;
receiving, by the at least one processor, an indication that at least one interaction has been initiated, the at least one interaction corresponding to a telecommunications interaction between a plurality of participants;
identifying, by the at least one processor, the persisted at least one data element that corresponds to each of the plurality of participants based on the association; and
automatically augmenting, by the at least one processor, at least one interaction record that corresponds to the at least one interaction with the identified at least one data element.

2. The method of claim 1, wherein the at least one data element includes employee information that relates to at least one from among employee name information, employee contact information, and employee association information.

3. The method of claim 2, wherein the employee contact information includes at least one from among telephone number information, email address information, and username information; and wherein the employee association information includes at least one from among corresponding employee identifier information and corresponding employer information.

4. The method of claim 1, further comprising:
assigning, by the at least one processor, a time characteristic to each of the at least one data element prior to persistence in the secured repository;
determining, by the at least one processor using the time characteristic, whether the at least one data element satisfies a predetermined threshold, the predetermined threshold relating to a predetermined retention time period; and
purging, by the at least one processor, the at least one data element from the secured repository when the predetermined threshold is satisfied.

5. The method of claim 1, further comprising:
receiving, by the at least one processor via the application programming interface, at least one external request that corresponds to at least one external telecommunication interaction, the at least one external request including unidentified participant information for at least one unidentified participant;
identifying, by the at least one processor, the persisted at least one data element that corresponds to the at least one unidentified participant based on the association and the unidentified participant information;
generating, by the at least one processor, at least one data set based on a predetermined guideline, the at least one data set including information relating to the identified at least one data element; and
transmitting, by the at least one processor via the application programming interface, the at least one data set in response to the at least one external request.

6. The method of claim 5, wherein the predetermined guideline relates to a distribution threshold that limits availability of the at least one data element for each of the at least one external request.

7. The method of claim 1, wherein, prior to associating the at least one data element with a corresponding employee, the method further comprises:
automatically validating, by the at least one processor, the aggregated employee data;
capturing, by the at least one processor based on a result of the automatically validating, supplemental data that corresponds to each of the at least one data element; and
associating, by the at least one processor, the captured supplemental data with the corresponding at least one data element.

8. The method of claim 7, wherein automatically validating the aggregated employee data further comprises:
determining, by the at least one processor, whether at least one telephone number in the aggregated employee data is duplicated; and
determining, by the at least one processor, whether contact information in the aggregated employee data matches at least one corresponding contact format, the at least one corresponding contact format including at least one from among a phone number format and a name format.

9. The method of claim 1, wherein at least one data retention policy is implemented to safeguard the at least one data element persisted in the secured repository, the at least one data retention policy including at least one from among an application programming interface limitation policy, a data persistence characteristic policy, and a permissible data retention preference policy.

10. A computing device configured to implement an execution of a method for facilitating automated participant identification and record augmentation via a secured repository, the computing device comprising:
a processor;
a memory; and
a communication interface coupled to each of the processor and the memory,
wherein the processor is configured to:
aggregate, via an application programming interface, employee data from at least one source according to a predetermined schedule, the employee data including at least one data element;
associate the at least one data element with a corresponding employee;
persist the association and the at least one data element in the secured repository;
receive an indication that at least one interaction has been initiated, the at least one interaction corresponding to a telecommunications interaction between a plurality of participants;
identify the persisted at least one data element that corresponds to each of the plurality of participants based on the association; and
automatically augment at least one interaction record that corresponds to the at least one interaction with the identified at least one data element.

11. The computing device of claim 10, wherein the at least one data element includes employee information that relates to at least one from among employee name information, employee contact information, and employee association information.

12. The computing device of claim 11, wherein the employee contact information includes at least one from among telephone number information, email address information, and username information; and wherein the employee association information includes at least one from among corresponding employee identifier information and corresponding employer information.

13. The computing device of claim 10, wherein the processor is further configured to:
assign a time characteristic to each of the at least one data element prior to persistence in the secured repository;
determine, by using the time characteristic, whether the at least one data element satisfies a predetermined threshold, the predetermined threshold relating to a predetermined retention time period; and
purge the at least one data element from the secured repository when the predetermined threshold is satisfied.

14. The computing device of claim 10, wherein the processor is further configured to:
receive, via the application programming interface, at least one external request that corresponds to at least one external telecommunication interaction, the at least one external request including unidentified participant information for at least one unidentified participant;
identify the persisted at least one data element that corresponds to the at least one unidentified participant based on the association and the unidentified participant information;
generate at least one data set based on a predetermined guideline, the at least one data set including information relating to the identified at least one data element; and
transmit, via the application programming interface, the at least one data set in response to the at least one external request.

15. The computing device of claim 14, wherein the predetermined guideline relates to a distribution threshold that limits availability of the at least one data element for each of the at least one external request.

16. The computing device of claim 10, wherein, prior to associating the at least one data element with a corresponding employee, the processor is further configured to:
automatically validate the aggregated employee data;
capture, based on a result of the automatic validation, supplemental data that corresponds to each of the at least one data element; and
associate the captured supplemental data with the corresponding at least one data element.

17. The computing device of claim 16, wherein, to automatically validate the aggregated employee data, the processor is further configured to:
determine whether at least one telephone number in the aggregated employee data is duplicated; and
determine whether contact information in the aggregated employee data matches at least one corresponding contact format, the at least one corresponding contact format including at least one from among a phone number format and a name format.

18. The computing device of claim 10, wherein the processor is further configured to implement at least one data retention policy to safeguard the at least one data element persisted in the secured repository, the at least one data retention policy including at least one from among an application programming interface limitation policy, a data persistence characteristic policy, and a permissible data retention preference policy.

19. A non-transitory computer readable storage medium storing instructions for facilitating automated participant identification and record augmentation via a secured repository, the storage medium comprising executable code which, when executed by a processor, causes the processor to:
aggregate, via an application programming interface, employee data from at least one source according to a predetermined schedule, the employee data including at least one data element;
associate the at least one data element with a corresponding employee;
persist the association and the at least one data element in the secured repository;
receive an indication that at least one interaction has been initiated, the at least one interaction corresponding to a telecommunications interaction between a plurality of participants;
identify the persisted at least one data element that corresponds to each of the plurality of participants based on the association; and
automatically augment at least one interaction record that corresponds to the at least one interaction with the identified at least one data element.

20. The storage medium of claim 19, wherein the at least one data element includes employee information that relates to at least one from among employee name information, employee contact information, and employee association information.
